(19) United States
(12) Patent Application Publication
(10) Pub. No.: US 2014/0152545 A1
(43) Pub. Date: Jun. 5, 2014

(54) DISPLAY DEVICE AND NOTIFICATION METHOD

(71) Applicant: Kabushiki Kaisha Toshiba, Tokyo (JP)

(72) Inventors: Hirokazu Nagata, Ota-ku (JP); Kazushige Ouchi, Saitama-shi (JP); Yoshiyasu Itoh, Mitaka-shi (JP)

(73) Assignee: Kabushiki Kaisha Toshiba, Tokyo (JP)

(21) Appl. No.: 13/951,192

(22) Filed: Jul. 25, 2013

(30) Foreign Application Priority Data
Nov. 30, 2012 (JP) 2012-263543

(51) Int. Cl. G06F 3/042; G06F 3/01

(52) U.S. Cl. CPC G06F 3/0425; G06F 3/017
USPC 345/156

(57) ABSTRACT

According to one embodiment, a display device includes: a display; an audio output module; a recognition module configured to recognize a time-series motion of a user; an issuing module configured to issue an operating instruction when the recognized time-series motion is a predetermined time-series motion; and a notification module configured to, when the time-series motion is recognized, notify the user of the recognized time-series motion by at least one of outputting of audio and displaying of an image on the display, regardless of whether the operating instruction is issued based on the recognized time-series motion.

### CROSS-REFERENCE TO RELATED APPLICATIONS

This application is based upon and claims the benefit of priority from Japanese Patent Application No. 2012-263543, filed Nov. 30, 2012, the entire contents of which are incorporated herein by reference.

### FIELD

Embodiments described herein relate generally to a display device and a notification method.

### BACKGROUND

Conventionally widely known are display devices, such as personal computers (PCs) and television receivers, that recognize a time-series motion, such as a gesture, made by a user based on a part of the user, such as a hand and a finger, and perform display corresponding to the motion thus recognized. Examples of the display corresponding to the time-series motion thus recognized may include changing of a display screen by switching channels correspondingly to a gesture made by the user.

In the conventional technology, when a display screen is changed correspondingly to the user's time-series motion thus recognized, the user cannot determine what kind of time-series motion is recognized to change the display screen. The user, for example, may possibly repeat a motion for lowering the hand with the palm facing a display device as a gesture for lowering the hand. In this case, there are two possible results: the display screen is changed by recognizing a motion for turning down the palm facing the display device as a gesture for lowering the hand; and the display screen is changed by recognizing a motion for turning up the hand thus turned down as a gesture for raising the hand. The user can determine that the gesture is recognized based on the change of the display screen but cannot readily determine which gesture described above is recognized.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a functional configuration of a display device according to a first embodiment;

FIG. 2 is an exemplary conceptual diagram of operations of the display device based on motions of a hand in the embodiment;

FIG. 3 is an exemplary flowchart of an operation of the display device in the embodiment;

FIG. 4 is an exemplary conceptual diagram of notification to a user with a pilot lamp in the embodiment;

FIG. 5 is an exemplary conceptual diagram of display of a pointer image on a display screen in the embodiment;

FIG. 6 is an exemplary conceptual diagram of display of a guide image on the display screen in the embodiment;

FIG. 7 is another exemplary conceptual diagram of display of the guide image on the display screen in the embodiment;

FIG. 8 is still another exemplary conceptual diagram of display of the guide image on the display screen in the embodiment;

FIG. 9 is yet another exemplary conceptual diagram of display of the guide image on the display screen in the embodiment;

FIG. 10 is an exemplary conceptual diagram of display of an animation image corresponding to a motion of the hand in the embodiment;

FIG. 11 is an exemplary conceptual diagram of display of the animation image corresponding to another motion of the hand in the embodiment;

FIG. 12 is an exemplary conceptual diagram of display of the animation image corresponding to still another motion of the hand in the embodiment; and

FIG. 13 is an exemplary block diagram of a functional configuration of a display device according to a second embodiment.

### DETAILED DESCRIPTION

In general, according to one embodiment, a display device comprises: a display; an audio output module; a recognition module configured to recognize a time-series motion of a user; an issuing module configured to issue an operating instruction when the recognized time-series motion is a predetermined time-series motion; and a notification module configured to, when the time-series motion is recognized, notify the user of the recognized time-series motion by at least one of outputting of audio and displaying of an image on the display, regardless of whether the operating instruction is issued based on the recognized time-series motion.

Embodiments of a display device and a notification method are described below in greater detail with reference to the accompanying drawings. While a television receiver is described as an example of the display device in the embodiments, the display device may be a personal computer (PC) as long as the PC has a display configuration, for example, and is not limited to the television receiver. Common components in the embodiments are denoted by like reference numerals, and an explanation thereof will be omitted.

### First Embodiment

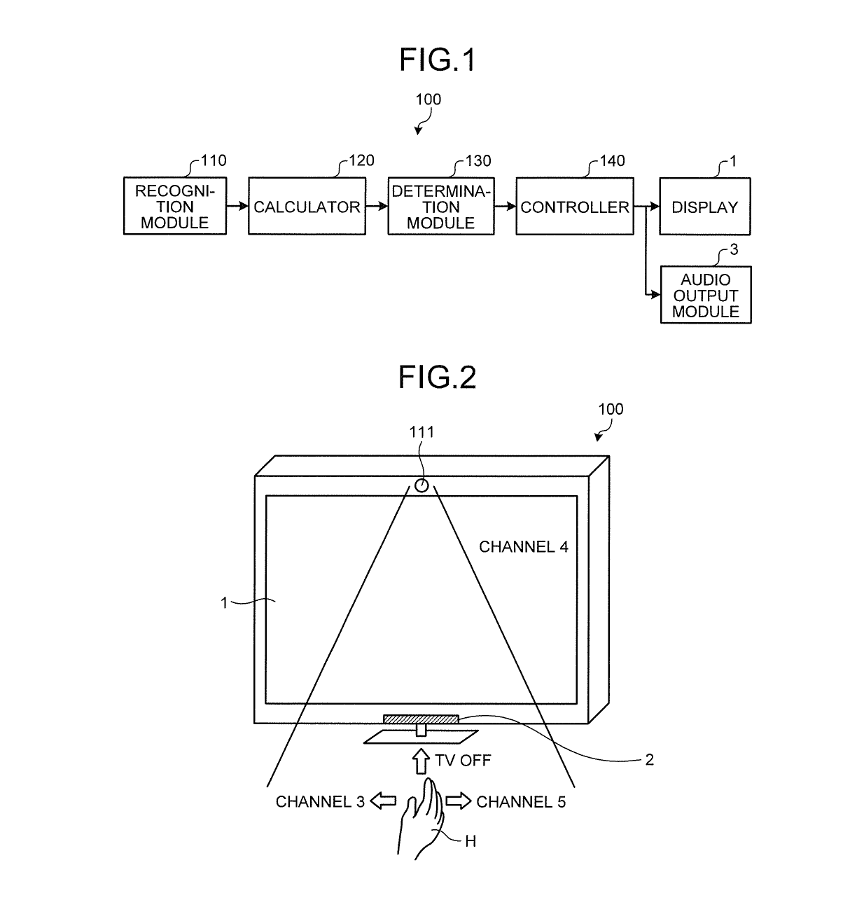

FIG. 1 is a block diagram of a functional configuration of a display device 100 according to a first embodiment. As illustrated in FIG. 1, the display device 100 is a television receiver comprising a display 1 and an audio output module 3. The display 1, such as a liquid crystal display (LCD), displays a received broadcast program. The audio output module 3, such as an amplifier and a speaker, outputs audio. In the display device 100, a central processing unit (CPU) loads computer programs stored in a read-only memory (ROM) onto a random access memory (RAM) and sequentially executes the computer programs (the CPU, the ROM, and the RAM are not illustrated) . As a result, the display device 100 has functions of a recognition module 110, a calculator 120, a determination module 130, and a controller 140.

The display device 100 recognizes a time-series motion (a gesture) of a user from an image captured by a digital camera 111 (refer to FIG. 2) formed of an image capturing element, such as an image sensor. The display device 100 then controls operations thereof correspondingly to the gesture thus recognized. In the first embodiment, the display device 100 recognizes a motion of a hand of the user as the time-series motion of the user. If the user makes a waving motion of the hand from side to side and up and down, the display device 100 receives an operation corresponding to the waving motion. A specific part used for detecting the motion of the user is not limited to a hand and may be any one of a head, a foot, and an eye or a combination of these parts, for example.

FIG. 2 is a conceptual diagram of an example of operations of the display device 100 based on motions of a hand H. As illustrated in FIG. 2, the digital camera 111 that captures the user serving as a subject is provided at a front and upper portion of the display device 100. The display device 100 is further provided with a pilot lamp 2 that lights up when the specific part (hand H) of the user is recognized and notifies the user of the fact that the specific part is being recognized at a front and lower portion of the display device 100. The positions of the digital camera 111 and the pilot lamp 2 are given just as an example and are not particularly limited to the positions illustrated in FIG. 2.

The digital camera 111 captures a time-series image (a moving image) at a predetermined frame rate. To operate display on the display 1, the user makes a waving motion of the hand H from side to side and up and down. In FIG. 2, the display 1 displays a “channel 4”. If the display device 100 receives a waving motion to the left of the hand H, the channel is switched to a “channel 3”. Similarly, if the display device 100 receives a waving motion to the right of the hand H, the channel is switched to a “channel 5”. If the display device 100 receives an upward waving motion of the hand H, “TV-OFF” is selected.

Referring back to FIG. 1, the recognition module 110 recognizes the specific part, such as the hand H, of the user serving as the subject in each image of the time-series image captured by the digital camera 111. Subsequently, the calculator 120 chronologically traces the specific part of the user recognized in each image, thereby deriving (recognizing) a motion of the specific part of the user chronologically. The position of the specific part to be recognized may be the center of gravity of a detection area of the hand H captured by the digital camera 111, for example. Alternatively, the position of the specific part may be represented by coordinates, such as a pixel position, specified on the image thus captured or by relative coordinates with respect to another part, such as a face, of the user thus detected.

In addition to the position, the recognition module 110 may store time at which each position is acquired. Assuming that the starting time of recognition of the specific part, such as the hand H, of the user is “0”, the time is represented by time elapsed from the starting time, the number of elapsed clocks, and the number of elapsed frames, for example. If the position is represented by (x,y) coordinates on the image thus captured, for example, the recognition module 110 stores a position (xi,yi) acquired from the i-th frame in association with time “Ti” of the acquisition.

The calculator 120 derives a motion of the specific part based on the position of the specific part, such as the hand H, and the time of acquisition of the position. Specifically, if the hand H in the image obtained by capturing the user who performs an operation facing the display device 100 repeats a motion for moving to the right at first and to the left subsequently, the calculator 120 determines that a waving motion to the left is being made. By contrast, if the hand H repeats a motion for moving to the left at first and to the right subsequently, the calculator 120 determines that a waving motion to the right is being made. Furthermore, if the hand H repeats a motion for moving upward at first and downward subsequently, the calculator 120 determines that an upward waving motion is being made. By contrast, if the hand H repeats a motion for moving downward at first and upward subsequently, the calculator 120 determines that a downward waving motion is being made.

The determination module 130 determines whether the time-series motion of the specific part, such as the hand H, of the user recognized by the calculator 120 is a predetermined motion set in advance in the ROM, for example. If waving motions to the left and to the right of the hand H are set as the predetermined motion, for example, the determination module 130 determines whether the motion of the user recognized by the calculator 120 is the waving motion to the left of the hand H or the waving motion to the right of the hand H.

If the shape of the specific part of the user recognized by the recognition module 110 is a predetermined shape, specifically, if the hand H is in a finger-pointing shape for pointing at the screen with the index finger, for example, the determination module 130 determines that the motion of the user is a pointing motion for operating a pointer (a cursor) displayed on the display 1. While determining that the motion of the user is the pointing motion, the determination module 130 receives a pointer operation corresponding to the motion of the specific part of the user derived (recognized) by the calculator 120.

Based on the predetermined motion and the pointer operation of the user determined by the determination module 130, the controller 140 issues an operating instruction corresponding to the predetermined motion and the pointer operation to control the display 1 and the audio output module 3. Thus, the controller 140 displays an image on the display 1 and outputs audio from the audio output module 3. If the time-series motion recognized by the recognition module 110 is the predetermined motion set in advance, for example, the controller 140 issues an operating instruction corresponding to the predetermined motion. Furthermore, if the recognition module 110 recognizes a time-series motion of the user, the controller 140 notifies the user of the time-series motion by displaying an image on the display 1 and outputting audio from the audio output module 3, regardless of whether an operating instruction is issued based on the time-series motion.

The controller 140 issues the operating instruction corresponding to the predetermined motion and the pointer operation and notifies the user of the time-series motion with reference to setting information set in advance in the ROM, for example. The setting information contains image information and audio information provided to the user correspondingly to the time-series motion of the user and time-series motions by which an operating instruction is issued in each operating mode of the display device 100. Examples of the operating modes may include a sleep mode, a display mode for displaying a received program, a video reproduction mode for displaying a recorded program, an incoming mode when there is an incoming call on a video phone, and a call mode for making a call on the video phone. The operating modes may be set for each graphical user interface (GUI). Specifically, for each GUI of a setting menu screen, an electronic program guide (EPG) screen, and an Internet browser screen, for example, time-series motions may be set by which an operating instruction is issued while the GUI is being displayed. The setting information may be the following data table, for example.

TABLE 1

| Time-series | | | Command to be |
|---|---|---|---|
| motion | Notification | Operating mode | issued |
| Waving motion | Animation | Sleep mode | None |
| to the left | image A | Display mode | Returning to a |
| | Audio A | | previous |
| | | | channel |
| | | Incoming mode | Receiving |
| | | Call mode | None |
| . . . | . . . | . . . | . . . |
| Downward | Animation | Sleep mode | TV ON |
| waving motion | image N | Display mode | None |
| | Audio N | Incoming mode | None |
| | | Call mode | None |

By referring to the setting information indicated in Table 1, the controller 140 can make a notification with an “animation image A” and “audio A” when a “waving motion to the left” is recognized, for example. If the “waving motion to the left” is recognized in a current operating mode of a “display mode”, the controller 140 issues an operating instruction (a command to be issued) of “returning to a previous channel”, thereby returning the channel on a display screen of the display 1 to the previous channel.

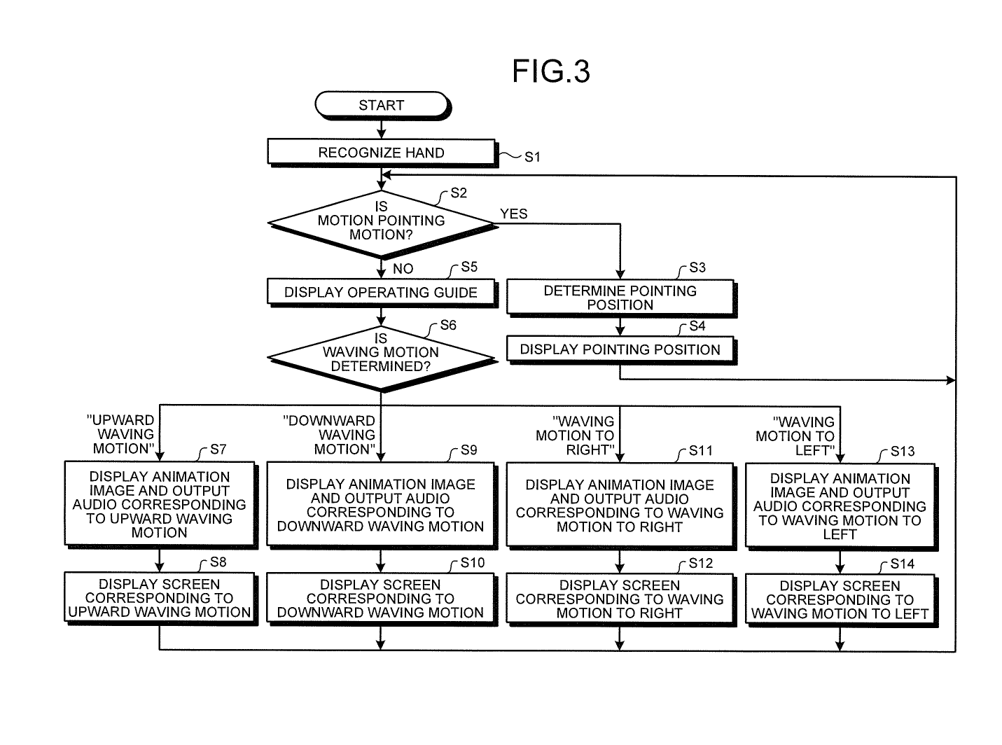

FIG. 3 is a flowchart of an example of an operation of the display device 100 in the first embodiment. As illustrated in FIG. 3, if the processing is started, the recognition module 110 recognizes the hand H as the specific part of the user based on an image captured by the digital camera 111 (S1).

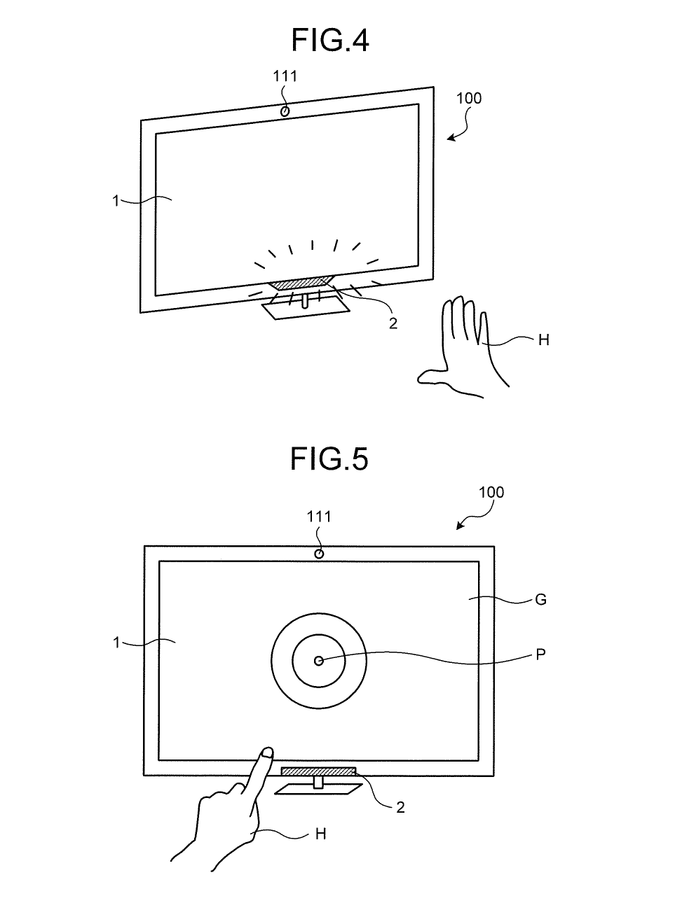

If the recognition module 110 recognizes the hand H from the image thus captured, the recognition module 110 lights up the pilot lamp 2 to notify the user of the fact that the hand His being recognized. FIG. 4 is a conceptual diagram of an example of notification to the user with the pilot lamp 2. As illustrated in FIG. 4, lighting-up of the pilot lamp 2 facilitates the user's noticing that the display device 100 is recognizing the hand H. This makes it possible to prevent the user from starting a waving motion before the display device 100 starts to recognize the hand H. As a result, it is possible to prevent an unintended motion from being recognized.

Subsequently, the determination module 130 determines whether the motion of the user is a pointing motion in which the shape of the hand of the user is a finger-pointing shape, for example (S2). If the motion of the user is the pointing motion (Yes at S2), the controller 140 determines a pointing position based on the shape of the hand H recognized by the recognition module 110 and the motion of the hand H of the user recognized by the calculator 120 (S3). The controller 140 then displays a pointer image at the pointing position thus determined (S4).

FIG. 5 is a conceptual diagram of an example of display of a pointer image P on a display screen G. As illustrated in FIG. 5, if the hand H is in the finger-pointing shape, the controller 140 displays the pointer image P like a ripple, for example, on the display screen G based on the direction of the index finger of the hand H in the image captured by the digital camera 111. Subsequently, the controller 140 moves the pointer image P in accordance with the motion of the hand H, thereby enabling the user to operate the pointer image P in an intended manner.

If the motion of the user is not the pointing motion (No at S2), the controller 140 displays an operating guide indicating a correspondence relation between a waving motion to be actually accepted among the waving motions of the hand H from side to side and up and down and an operating instruction corresponding to the waving motion on the display screen G (S5). The operating guide is displayed on the display screen G to indicate waving motions to be received in the current operating mode (e.g., the sleep mode, the display mode, the incoming mode, and the call mode) and the contents of an operating instruction issued when a waving motion is made with reference to the setting information described above. The operating guide may be provided to the user by audio output from the audio output module 3 in addition to the operating guide displayed on the display screen G.

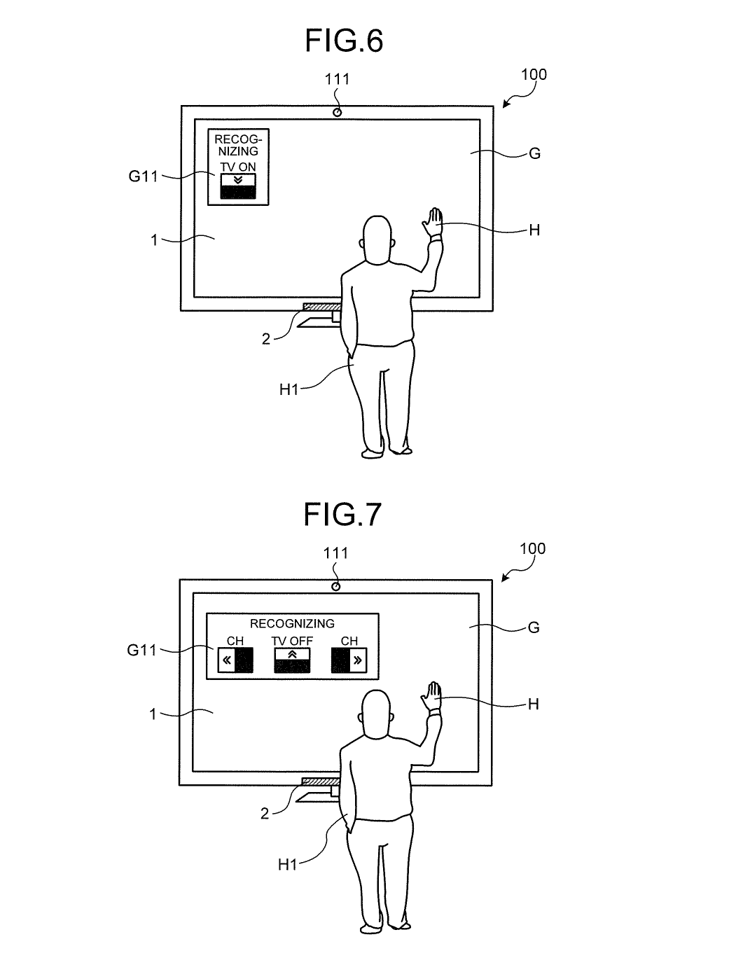

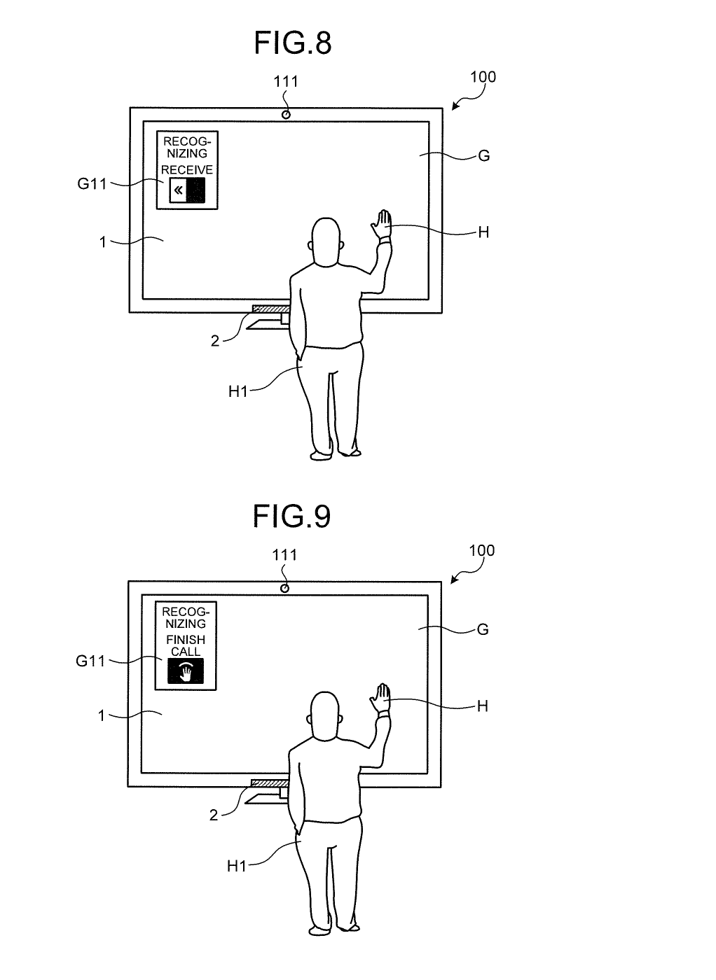

FIG. 6 to FIG. 9 are conceptual diagrams of an example of display of a guide image Gil on the display screen G. Specifically, FIG. 6 is a conceptual diagram exemplifying the guide image Gil displayed when a user H1 holds up the hand H and the hand H is recognized in the sleep mode. Similarly, FIG. 7 is a conceptual diagram exemplifying the guide image Gil displayed when the hand H is recognized in the display mode. FIG. 8 is a conceptual diagram exemplifying the guide image G11 displayed when the hand H is recognized in the incoming mode. FIG. 9 is a conceptual diagram exemplifying the guide image G11 displayed when the hand H is recognized in the call mode. As illustrated in FIG. 6 to FIG. 9, the guide image G11 displays waving motions to be received in the current operating mode and the contents of an operating instruction issued when a waving motion is made correspondingly to each operating mode. Therefore, the guide image G11 enables the user to check in advance what kind of operation is to be performed by making a waving motion of the hand H.

Subsequently, the determination module 130 determines the waving motion of the hand H thus recognized (S6). The controller 140 then displays an image on the display 1 and outputs audio to the audio output module 3 based on the waving motion thus determined (S7 to S14).

Specifically, if the motion of the user is the “upward waving motion” of the hand H, the controller 140 displays an animation image corresponding to the upward waving motion on the display screen G and outputs audio corresponding to the upward waving motion (S7). The controller 140 then displays the display screen G corresponding to the upward waving motion (S8), and the system control is returned to S2. The controller 140 simply needs to perform at least one of displaying an animation image on the display screen G and outputting audio corresponding to the upward waving motion and need not perform the both.

In the display mode, for example, after displaying the animation image corresponding to the upward waving motion and outputting the audio corresponding thereto, the controller 140 turns off the display of the program on the display screen G. If there is no operating instruction corresponding to the upward waving motion like “in the sleep mode”, the controller 140 displays the animation image corresponding to the upward waving motion and outputs the audio corresponding thereto, and the system control is returned to S2 without performing the processing at S8. Displaying an animation image corresponding to the upward waving motion and outputting audio corresponding thereto in this manner facilitate the user's noticing that the upward waving motion of the hand H is recognized.

If the motion of the user is the “downward waving motion” of the hand H, the controller 140 displays an animation image corresponding to the downward waving motion on the display screen G and outputs audio corresponding to the downward waving motion (S9). The controller 140 then displays the display screen G corresponding to the downward waving motion (S10), and the system control is returned to S2.

In the sleep mode, for example, after displaying the animation image corresponding to the downward waving motion and outputting the audio corresponding thereto, the controller 140 turns on the display of the program on the display screen G. If there is no operating instruction corresponding to the downward waving motion like “in the display mode”, the controller 140 displays the animation image corresponding to the downward waving motion and outputs the audio corresponding thereto, and the system control is then returned to S2 without performing the processing at S10. Thus, it is possible to facilitate the user's noticing that the downward waving motion of the hand H is recognized.

If the motion of the user is the “waving motion to the right” of the hand H, the controller 140 displays an animation image corresponding to the waving motion to the right on the display screen G and outputs audio corresponding to the waving motion to the right (S11). The controller 140 then displays the display screen G corresponding to the waving motion to the right (S12), and the system control is returned to S2.

In the display mode, for example, after displaying the animation image corresponding to the waving motion to the right and outputting the audio corresponding thereto, the controller 140 changes a display channel (CH) on the display screen G to a subsequent channel. If there is no operating instruction corresponding to the waving motion to the right like “in the sleep mode”, the controller 140 displays the animation image corresponding to the waving motion to the right and outputs the audio corresponding thereto, and the system control is then returned to S2 without performing the processing at S12. Thus, it is possible to facilitate the user's noticing that the waving motion to the right of the hand H is recognized.

If the motion of the user is the “waving motion to the left” of the hand H, the controller 140 displays an animation image corresponding to the waving motion to the left on the display screen G and outputs audio corresponding to the waving motion to the left (S13). The controller 140 then displays the display screen G corresponding to the waving motion to the left (S14), and the system control is returned to S2.

In the display mode, for example, after displaying the animation image corresponding to the waving motion to the left and outputting the audio corresponding thereto, the controller 140 changes the display channel (CH) on the display screen G to a previous channel. If there is no operating instruction corresponding to the waving motion to the left like “in the sleep mode”, the controller 140 displays the animation image corresponding to the waving motion to the left and outputs the audio corresponding thereto, and the system control is then returned to S2 without performing the processing at S14. Thus, it is possible to facilitate the user's noticing that the waving motion to the left of the hand H is recognized.

The notification by displaying an animation image corresponding to a waving motion and outputting audio corresponding thereto is made prior to changing the display screen G. Therefore, the user can check whether the motion is properly recognized when the display on the display screen G is changed by the waving motion.

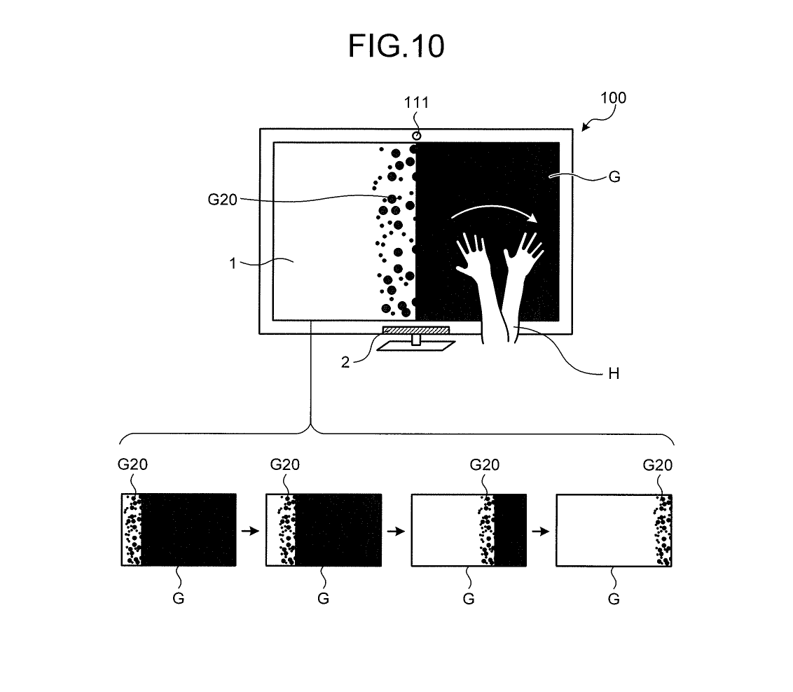

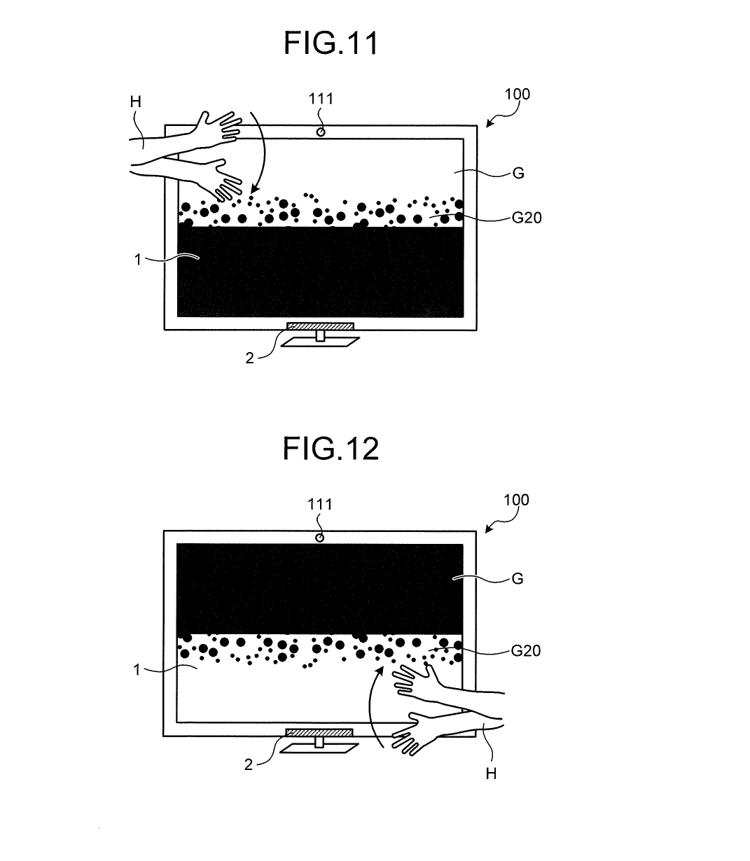

FIG. 10 to FIG. 12 are conceptual diagrams of an example of display of an animation image G20 corresponding to a motion of the hand H. Specifically, FIG. 10 is a conceptual diagram of an example of display of the animation image G20 corresponding to the waving motion to the right of the hand H. FIG. 11 is a conceptual diagram of an example of display of the animation image G20 corresponding to the downward waving motion of the hand H. FIG. 12 is a conceptual diagram of an example of display of the animation image G20 corresponding to the upward waving motion of the hand H.

As illustrated in FIG. 10 to FIG. 12, if a waving motion of the hand H is made, the animation image G20 that flows in the waving direction is displayed on the display screen G. This facilitates the user's determining of the waving direction recognized by the display device 100. Similarly, audio that flows in the waving direction may be output to indicate the waving direction by controlling sound localization with a plurality of speakers.

The animation image G20 is an image of a translucent dot pattern displayed in a superimposed manner on the display screen G, for example. In the examples illustrated in FIG. 10 to FIG. 12, the animation image G20 moves on the display screen G in a display manner covering a part of the display screen G in a direction parallel to the flowing direction of the image G20 and covering the whole area of the display screen G in a direction orthogonal to the flowing direction of the image G20. In other words, dots in the dot pattern of the animation image G20 flow from one end to the other end of the display screen G in a manner scattered in the whole area of the screen G in the direction parallel to the flowing direction of the image G20 and scattered only in a part of the area of the screen G in the direction orthogonal to the flowing direction of the image G20. The display manner of the animation image G20 is not limited thereto, and the animation image G20 may be set so as to flow in a display manner covering the whole area of the display screen G for a certain period of time, for example.

In transition of the display screen G to another display screen in association with input of a gesture, the display screen G may be changed to a screen to be displayed after the transition subsequently to completion of display of the animation image G20. Alternatively, the display screen G may be gradually changed along with the movement of the animation image G20 as illustrated in FIG. 10 to FIG. 12. In other words, if the screen originally displayed is represented by a black area, and the screen to be displayed after the transition is represented by a white area as illustrated in a screen transition diagram located on the lower part of FIG. 10, the screen to be displayed after the transition (white area) may gradually appear in association with the movement of the animation image G20 flowing from the left side of the display screen G.

While display of the animation image G20 and changing of the display screen G are performed in parallel in the examples illustrated in FIG. 10 to FIG. 12, the animation image G20 simply needs to be displayed when a predetermined time-series motion is detected as indicated in Table 1. In other words, the display device 100 need not necessarily change the display screen G when displaying the animation image G20. If the display device 100 detects an upward or downward waving motion, for example, the display device 100 may turn up or down the volume while displaying the image G20 without changing the display screen G20. Furthermore, if a predetermined time-series motion is detected, the display device 100 displays the animation image G20 even if there is no command corresponding to the motion.

While the direction of a waving motion alone is detected in the first embodiment, the calculator 120 may recognize a degree of the waving motion, such as a time period of the waving motion (a time period from the start of the waving motion to the end thereof) and the speed of the waving motion, to display an animation image and output audio correspondingly to the degree of the waving motion thus recognized. Specifically, if the degree of the waving motion is large (if the time period of the waving motion is short or if the speed of the waving motion is fast), the animation image may flow faster.

### Second Embodiment

A second embodiment will now be described. The second embodiment is different from the first embodiment in that a time-series motion of the user is recognized using a remote controller held with a hand and operated by the user.

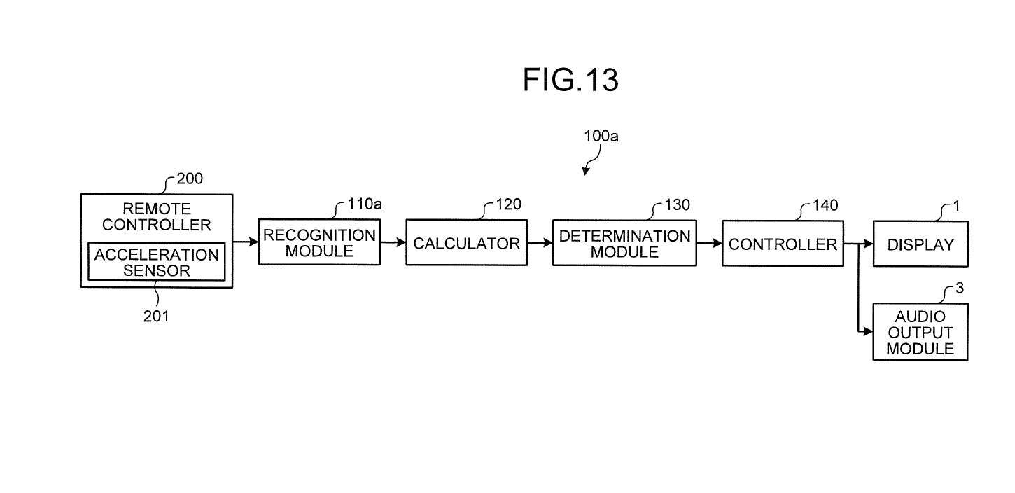

FIG. 13 is a block diagram of a functional configuration of a display device 100a according to the second embodiment. As illustrated in FIG. 13, a recognition module 110a of the display device 100a recognizes a waving motion of a remote controller 200 of the user based on a detected value obtained by an acceleration sensor 201 and transmitted from the remote controller 200. Specifically, the acceleration sensor 201 detects the acceleration of the remote controller 200 in directions from side to side and up and down. Subsequently, the recognition module 110a recognizes a waving motion in the directions from side to side and up and down from a wave form of the acceleration. If a wave form is detected in which the upward acceleration increases at first and the downward acceleration increases subsequently, for example, the recognition module 110a recognizes that an upward waving motion is made. Similarly, the recognition module 110a recognizes a downward waving motion and waving motions to the right and to the left based on the wave form of the acceleration.

The computer program executed in the display devices 100 and 100a according to the first and the second embodiments, respectively, may be provided in a manner previously incorporated in a ROM, for example. The computer program executed in the display devices 100 and 100a according to the first and the second embodiments, respectively, may be provided in a manner recorded in a computer-readable recording medium, such as a compact disk read-only memory (CD-ROM), a flexible disk (FD), a compact disk recordable (CD-R), and a digital versatile disk (DVD), as a file in an installable or executable format.

The computer program executed in the display devices 100 and 100a according to the first and the second embodiments, respectively, may be provided in a manner stored in a computer connected to a network such as the Internet to be made available for downloads via the network. Furthermore, the computer program executed in the display devices 100 and 100a according to the first and the second embodiments, respectively, may be provided or distributed over a network such as the Internet.

The computer program executed in the display devices 100 and 100a according to the first and the second embodiments, respectively, has a module configuration comprising the functional configuration described above. In actual hardware, the CPU (processor) reads and executes the computer program from the ROM described above to load the functional configuration described above on the main memory. Thus, the functional configuration is generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display;
an audio output module;
a recognition module configured to recognize a time-series motion of a user;
an issuing module configured to issue an operating instruction when the recognized time-series motion is a predetermined time-series motion; and
a notification module configured to, when the time-series motion is recognized, notify the user of the recognized time-series motion by at least one of outputting of audio and displaying of an image on the display, regardless of whether the operating instruction is issued based on the recognized time-series motion.

2. The display device of claim 1, wherein the issuing module is configured to issue the operating instruction when the recognized time-series motion corresponds to a time-series motion specified in a current operating mode based on setting information that specifies a time-series motion by which the operating instruction is issued in each operating mode of the display device.

3. The display device of claim 1, wherein the notification module is configured to, when the operating instruction is issued based on the recognized time-series motion, notify the user of the time-series motion prior to a motion corresponding to the operating instruction.

4. The display device of claim 1, wherein the notification module is configured to, while receiving the time-series motion of the user, notify the user of an operating guide indicating a correspondence relation between the predetermined time-series motion and the operating instruction by at least one of outputting of audio and displaying of a guide image.

5. The display device of claim 1, further comprising:
an image capturing module configured to capture the user, wherein
the recognition module is configured to recognize a time-series motion of a predetermined part of the captured user.

6. The display device of claim 5, wherein
the recognition module is configured to recognize a motion of a hand of the user, and
the issuing module is configured to issue the operating instruction based on whether a waving motion of the hand of the user is made in a predetermined direction.

7. The display device of claim 1, further comprising:
a remote controller configured to be used by the user, wherein
the recognition module is configured to recognize the time-series motion of the user based on a motion of the remote controller.

8. The display device of claim 1, wherein display of an image indicating the time-series motion is display of an animation image corresponding to the time-series motion.

9. A notification method of a display device comprising a display and an audio output module, the notification method comprising:
recognizing, by a recognition module, a time-series motion of a user;
issuing, by an issuing module, an operating instruction when the recognized time-series motion is a predetermined time-series motion; and
notifying, by a notification module, when the time-series motion is recognized, the user of the recognized time-series motion by at least one of outputting of audio and displaying of an image on the display, regardless of whether the operating instruction is issued based on the recognized time-series motion.
